(19) United States
(12) Patent Application Publication
(10) Pub. No.: US 2024/0181991 A1
(43) Pub. Date: Jun. 6, 2024

(54) WINDOW WIPER

(71) Applicant: Michigan Aerospace Corporaation, Ypsilanti, MI (US)

(72) Inventor: William Eric JOHNSON, Saline, MI (US)

(21) Appl. No.: 18/285,225

(22) PCT Filed: Mar. 30, 2022
(86) PCT No.: PCT/US2022/022512

§ 371 Date: Sep. 29, 2023

Related U.S. Application Data
(60) Provisional application No. 63/168,348, filed on Mar. 31, 2021.

(51) Int. Cl. B60S 1/44

(52) U.S. Cl. CPC B60S 1/44

(57) ABSTRACT

A flexible wiper blade is attached at each end to motor driven pivot points. When material needs to be cleared from the window surface, the motorized pivot points rotate in a controlled fashion to flex the wiper out into the window area sweeping debris away as the wiper moves. At the other end of motion, the wiper blade is again flexed mostly out of the clear aperture of the window but on the other side of the window's edge.

This application claims priorities to the PCT Application No. PCT/US2022/022512 filed on Mar. 30, 2022, and the U.S. Provisional Application No. 63/168,348 filed on Mar. 31, 2021, the entire disclosure of which is hereby incorporated by reference.

### I. BACKGROUND OF INVENTION

### A. Scope of the Invention

As shown in FIG. 1, conventional window wipers sweep out a portion of a circle inset into a window. Unfortunately, this means that a large fraction of the window surface is not swept over by the wiper. Alternatively, the wiper blade can be made long enough to sweep the window off completely, but this approach causes a large portion of the wiper blade to leave the glass at each end of its travel. In addition, this approach requires an arm whose center of rotation is far from the window's edge increasing the area requirements of the wiper arm/window/blade. In space constrained situations where windows are used such as portholes and optical remote sensing apertures, it is desirable to clear off as much window surface as possible.

### B. Summary of the Prior Art

Currently wipers for windows only clear a portion of the window, as illustrated by FIG. 1. As a result, this requires a larger window than necessary for the optical application to ensure a clear and optimal transmission. In the case of a Light Detection And Ranging (LiDAR) system, maximizing the transmitting and/or receiving light will improve the detection limit. Large windows are expensive and the cost increase with size is not linear such that increasing the window size would significantly increase the window cost. Furthermore, the unwiped/unused portion of the window can have negative effects on the overall system. For example, accumulated particles on the unwiped surface of a LiDAR optical port will indiscriminately scatter light and contaminate the light collected from the scene.

Another solution would be to use a wiper that is larger than the window and sweep it beyond the edge of the window. In this scenario, the window edges must be flush with the surrounding material or there is the potential for there to be a gap at the seam between the window and the material that surrounds the window. A larger system footprint would be required of this approach. Applicant has found that such conventional approaches are insufficient to meet the needs of applications using portholes of optical remote sending apertures.

### II. SUMMARY OF THE INVENTION

FIGS. 2A-2I show examples where a flexible wiper blade is attached at each end to motor driven pivot points. Initially, a flexible wiper blade is attached at each end to motor driven pivot points. Initially (left) the wiper is in a position that leaves the bulk of the clear aperture unobstructed. When material needs to be cleared from the window surface, the motorized pivots rotate in a controlled fashion to flex the wiper out into the window area (FIGS. 2B, 2E, 2H) sweeping debris away as the wiper moves. At the other end of motion, the wiper blade is again flexed mostly out of the clear aperture of the window but on the other side of the window's edge (FIGS. 2C, 2F, 2I). FIGS. 2A-2I show examples where the motorized pivot points lie outside the clear aperture of the window. FIGS. 3A-3I show examples where the motorized pivots lie inside the circumference of the clear aperture for situations where the wiper and its supporting structure cannot exceed the perimeter of the clear aperture. A flexible wiper blade is attached at each end to motor driven pivot points.

In operation, initially (left) the wiper is in a position that leaves the bulk of the clear aperture unobstructed. When material needs to be cleared from the window surface, the motorized pivots rotate in a controlled fashion to flex the wiper out into the window area (FIGS. 2B, 2E, 2H) sweeping debris away as the wiper moves. At the other end of motion, the wiper blade is again flexed mostly out of the clear aperture of the window but on the other side of the window's edge (FIG. 2C, 2F, 2I). In FIGS. 2A, 2D and 2G, the wiper is in a position that leaves the bulk of the clear aperture unobstructed. When material needs to be cleared from the window surface, the motorized pivots rotate in a controlled fashion to flex the wiper out into the window area (see FIGS. 2B, 2E, 2H) sweeping debris away as the wiper moves. At the other end of motion, the wiper blade is again flexed mostly out of the clear aperture of the window but on the other side of the window's edge (FIGS. 2C, 2F, 2I).

### III. BRIEF DESCRIPTION OF THE DRAWINGS

The present invention is illustrated in the accompanying drawings, wherein:

FIGS. 1A-1C are illustrations of the prior art;

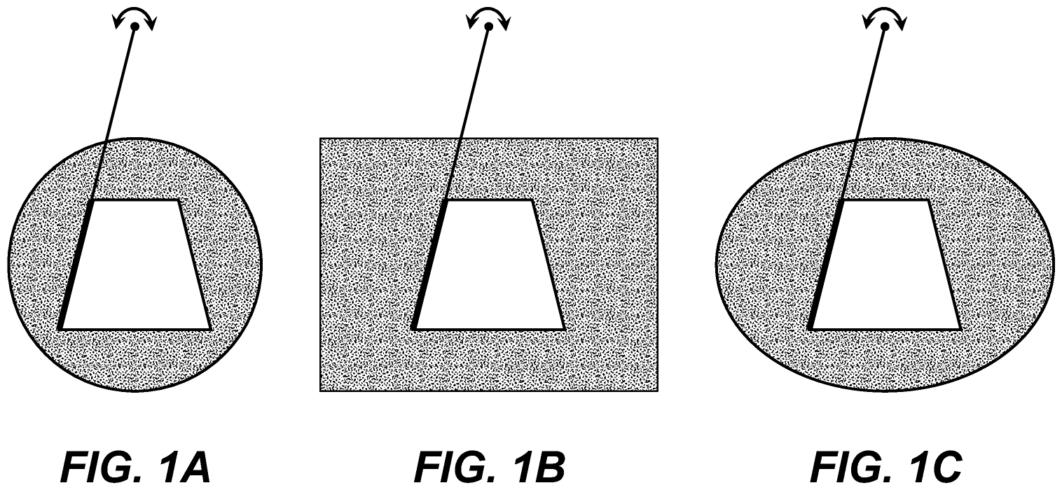

FIGS. 2A-2C show the beginning, middle, and end of a sweep where the motors are mounted outside the edge of an elliptical or non-circular window;

FIGS. 2D-2F show the beginning, middle, and end of a sweep where the motors are mounted outside the edge of a rectangular window;

FIGS. 2G-2I show the beginning, middle, and end of a sweep where the motors are mounted outside the edge of a circular window;

FIGS. 3A-3C show the beginning, middle, and end of a sweep where the motors are mounted inside the edge of an elliptical or non-circular window;

FIGS. 3D-3F show the beginning, middle, and end of a sweep where the motors are mounted inside the edge of a rectangular window;

FIGS. 3A-3C show the beginning, middle, and end of a sweep where the motors are mounted inside the edge of a circular window; and

FIG. 4 is a system block diagram of the window wiper system according to the present invention.

### IV. DESCRIPTION OF THE PREFERRED EMBODIMENT

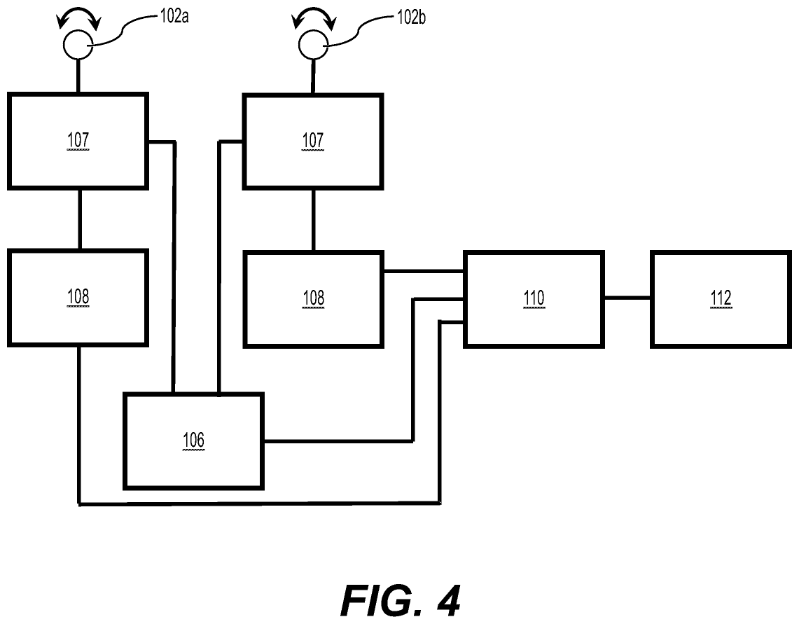

The embodiments of the present invention will be described hereinbelow in conjunction with the above-described drawings. [symbol] embodiment described herein is that of a circular window only for purposes of example. However, the present invention may be applied to windows of any shape or size, including those of elliptical and polygon-shape. As shown in FIG. 4, in at least one embodiment, the window wiper system 100 consists of two motor driven pivot points 102a, 102b, the wiper blade 104, a motor driver 106, pivot point position sensor 108, user interface 110 and a power supply 112. The pivot points 102a, 102b are generally located on opposite sides of the window 114 on a line that intersects the center of the window 114. [symbol] pivots, pivot mountings, and motors should be located so that the pivot points, pivot mounting, and motors do not touch the window 114. The length of the wiper blade 104 is generally determined as half the distance between the pivot points 102a, 102b multiplied by pi for a circular window or at least an area of the window to be wiped that is circular- or near circular-shaped. For non-circular windows, additional length would be required to circumscribe at least a majority of the shape's circumference. A sufficient amount of extra length is added to the calculated length to ensure that the wiper blade 104 is held securely by the pivot points 102a, 102b. The interface between the wiper blade 104 and each of the pivot points 102a, 102b should be designed to produce a force that pushes the wiper blade 104 onto the window 114 while keeping the wiper blade 104 and pivot points 102a, 102b aligned with each other. This force would accommodate the wiper blade on windows that are concave or convex in cross-section.

The wiper blade 104 is made from a flexible rubber like material that is held in contact with the widow 114. The wiper material selection must include considerations of flexibility, expected environmental considerations such as de-icing fluid, or window cleaning solution, and any coatings the window may have.

Moving the wiper blade 104 occurs when the motor driver 106 rotates the pivot points 102a, 102b. In at least one embodiment, the motor driver 106 is connected to a first one 102a of the pivot points 102a, 102b wherein the second one 102b is simply a fixed pivot element to which a far end of the wiper blade 104 is connected so as to allow the far end of the wiper blade 104 to follow the flexing movement of the wiper blade 104 as the motor driver 106 drivingly rotates the first one 102a of the pivot points to flex the wiper blade 104 across the circular window 114. The motor driver 106 can also drive the first one 102a of the pivot points in a reverse direction in a similar motion.

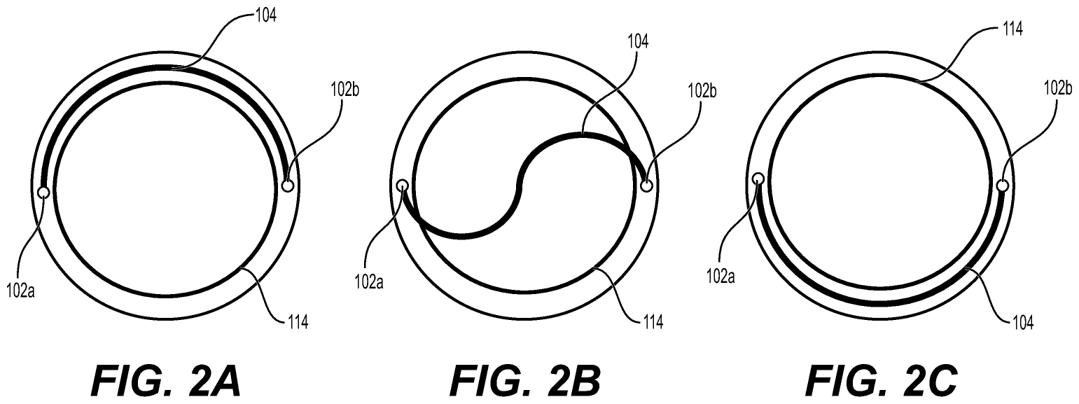

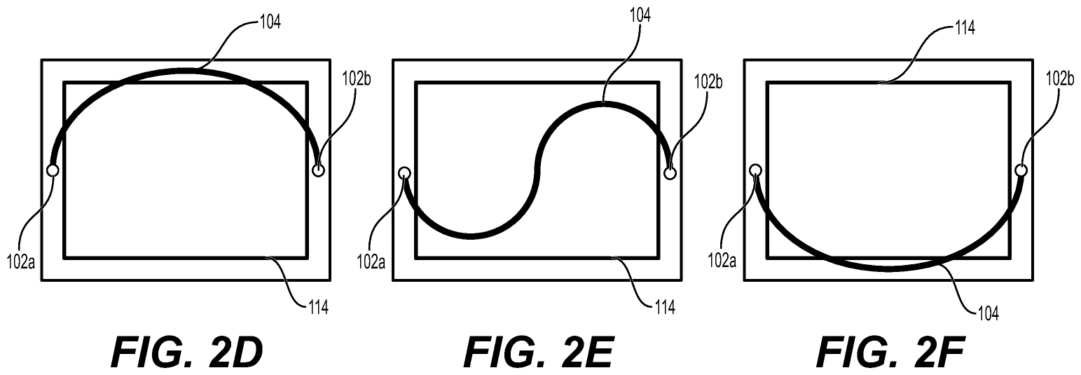

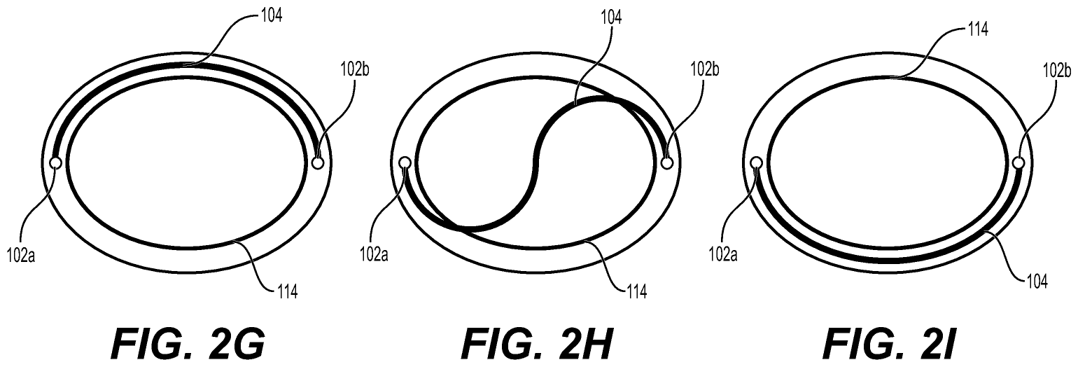

Among the embodiments of the present invention, the window 114 in at least one embodiment, as shown in FIGS. 2A-2C, the window 114 may be elliptically-shaped. In another embodiment, as shown in FIGS. 2D-2F, the window 114 may be rectangular-shaped. In a further embodiment, as shown in FIGS. 2G-2I, the window 114 may be circular-shaped.

With reference to the embodiment shown in FIGS. 2G-2I wherein the window 114 is circular-shaped, only for purposes of an example, the motor driver 106 is connected to both the pivot points 102a, 102b wherein the motor driver 106 coordinates the pivoting movement of the second one 102b relative to the first one 102a of the pivot points so as to allow the far end of the wiper blade 104 to follow the flexing movement of the wiper blade 104 as the motor driver 106 drivingly rotates the first one 102a of the pivot points to flex the wiper blade 104 across the window 114. In The motor driver 106 can also drive either of the pivot points 102a, 102b in a reverse direction in coordination with the pivoting of the other pivot point in a similar motion.

The pivot point position sensor 108 connected to each pivot points 102a, 102b, or alternatively a pivot point position sensor 108 mounted on each of the pivot points 102a, 102b provides the feedback necessary to smoothly rotate the pivot points 102a, 102b with the motor driver 106 synchronizing pivot point rotation that will provide a smooth wipe by the wiper blade 104.

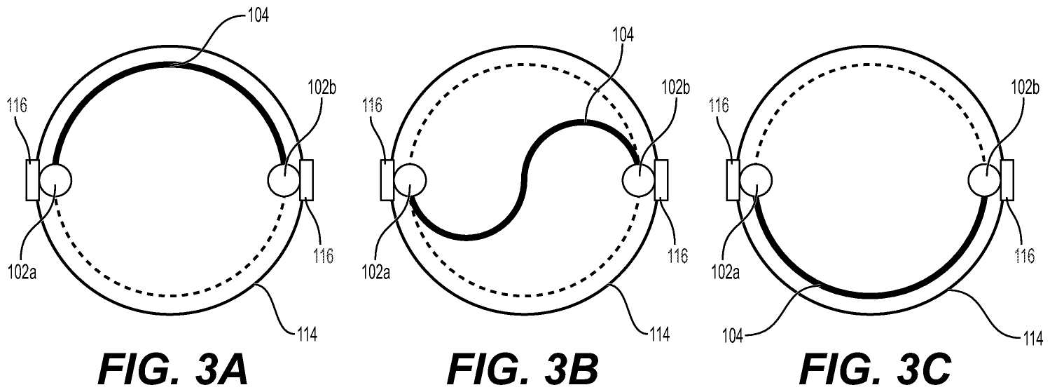

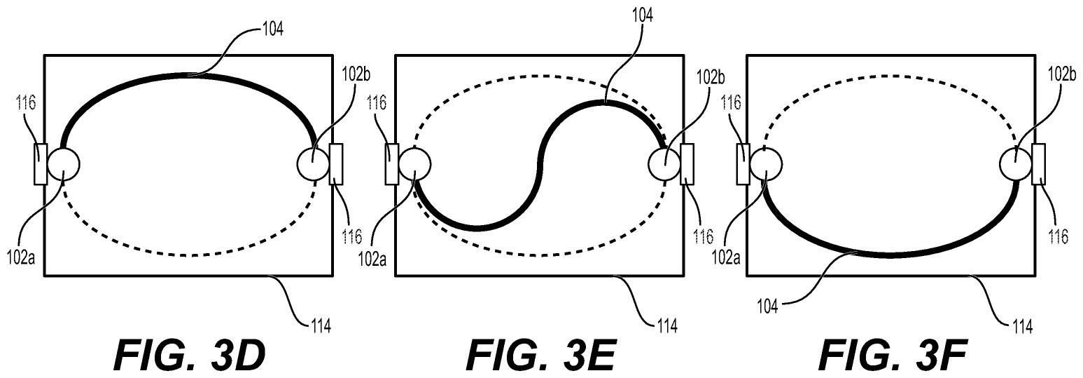

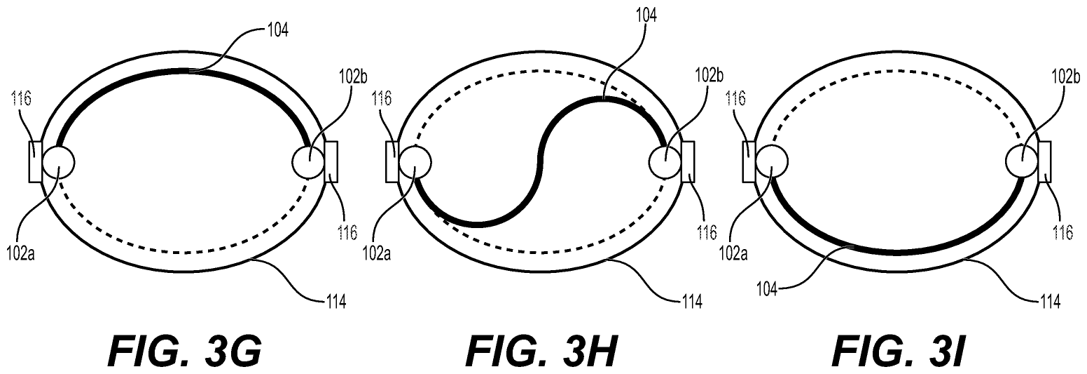

In an alternative embodiment, the pivot points are located inside the window's edge as shown in FIGS. 3A-3C wherein the window 114 may be elliptically-shaped. In another alternative embodiment, as shown in FIGS. 3D-3F, the window 114 may be rectangular-shaped. In a further alternative embodiment, as shown in FIGS. 3G-3I, the window 114 may be circular-shaped.

With reference to FIGS. 3G-3I, only for purposes of example, one implementation of these alternative embodiments would include one or more mounting holes defined in the window 114 itself. Putting holes in the window is not favored as there is potential for the window to be warped by putting mounting holes in the window. In this implementation of the alternative embodiment, as shown in FIGS. 3G-3I, the pivot points 102a, 102b would be mounted on mounting tabs 116 that extend over the outer periphery of the window 114 but not contacting the surface of the window 114. The pivot points 102a, 102b would extend downward underneath the mounting tabs so as to mount the wiper blade 104 between the downward extending pivot points 102a, 102b and in contact with the surface of the window 114. The motor driver 106 would then be connected to one or both of the pivot points 102a, 102b, and the operation of the wiper blade 104 would be the same as in the previous embodiment described hereinabove.

In operation, with reference to FIGS. 2G-2I as an example, initially the wiper blade 104 is in a position that leaves the bulk of the surface of the window 114 unobstructed. In this embodiment of a circular window, as shown in FIG. 2G, the initial position has the wiper blade 104 in a semicircular curved state along the upper, outer peripheral edge of the circular window 114. When material needs to be cleared from the window surface, the motorized pivot points 102a, 102b rotate in a controlled fashion to flex the wiper blade 104 out into the window area (FIG. 2H) sweeping debris away as the wiper moves. At the other end of motion, the wiper blade 104 is again flexed mostly out of the clear aperture of the circular window 114 but on the other side of the circular window 114 along the lower outer peripheral edge (see FIG. 2I).

In a similar motion, in a reverse direction, starting with the wiper blade 104 in a semicircular curved state along the lower, outer peripheral edge of the circular window 114, the motorized pivot points 102a, 102b again rotate in a controlled fashion to flex the wiper blade 104 out into the window area sweeping debris away as the wiper moves. At the other end of this reverse motion, the wiper blade 104 is again flexed mostly out of the clear aperture of the circular window 114 but on the other side of the circular window 114 along the upper, outer peripheral edge.

Although the present invention has been fully described in connection with the preferred embodiment thereof with reference to the accompanying drawings, it is to be noted that various changes and modifications will be apparent to those skilled in the art. Changes and modifications made to the embodiments of the present invention as disclosed hereinabove to accommodate non-circular windows shall be considered apparent to those skilled in the art. Such changes and modifications are to be understood as included within the scope of the present invention as defined by the appended claims unless they depart therefrom.

I/we claim:

1. A window wiper system, comprising:
first and second pivot elements;
a flexible wiper blade operatively connected between the first and second pivot elements; and [symbol]
a motor driver operatively connected to the first and second pivot elements to controllably and reversibly rotate the first and second pivot elements relative to each other, wherein
the flexible wiper blade is connected between the first and second pivot elements so as to be maintained in a half circumference state at a first position along a first peripheral portion of a window, and
the motor driver is configured to rotate the first and second pivot elements such that the flexible wiper blade is flexibly moves across a surface of the window to a second position along a second peripheral portion of the window.

2. A window wiper system according to claim 1, further comprising:
a pivot point position sensor operatively connected to at least one of the first and second pivot elements and configured to determine a position of the at least one of the first and second pivot elements.

3. A window wiper system according to claim 1, wherein the motor driver is operatively connected to the first pivot element so as to actively drive rotation of the first pivot element, the second pivot element being operatively connected to be passively driven in response to rotation of the first pivot element.

4. A window wiper system according to claim 1, wherein the motor driver is operatively connected to the first and second pivot elements so as to actively drive rotation of the first and second pivot elements.

5. A window wiper system according to claim 1, wherein the first and second pivot elements are mounted on opposite sides of the window along a line intersecting a center of the window.

6. A window wiper system according to claim 5, wherein the first and second pivot elements are mounted on opposite sides outside an outer periphery of the window.

7. A window wiper system according to claim 5, wherein the first and second pivot elements are mounted on opposite sides inside an outer periphery of the window.

8. [symbol] A window wiper system according to claim 6, wherein the first and second pivot elements are mounted on opposite sides each on a mounting tab that extends over an outer periphery of the window.

9. A window wiper system according to claim 1, wherein the window is circular-shaped.

10. A window wiper system according to claim 1, wherein the window is elliptical-shaped.

11. A window wiper system according to claim 1, wherein the window is rectangular-shaped.

12. A method for wiping a window, comprising the steps of:
providing a window wiping structure that includes first and second pivot elements, a flexible wiper blade operatively connected between the first and second pivot elements and a motor driver operatively connected to the first and second pivot elements, wherein the flexible wiper blade is connected between the first and second pivot elements so as to be maintained in a half circumference state at a first position along a first peripheral portion of a window;
operating the motor driver to rotate the first and second pivot elements to flexibly move the flexible wiper blade across a surface of the window to a second position along a second peripheral portion of the window; and
further operating the motor driver to controllably and reversibly rotate the first and second pivot elements relative to each other.

13. A method for wiping a window according to claim 12, further comprising the steps of:
providing a pivot point position sensor operatively connected to at least one of the first and second pivot elements; and
determining a position of the at least one of the first and second pivot elements via the pivot point position sensor.

14. A method for wiping a window according to claim 12, wherein the motor driver is operatively connected to the first pivot element so as to actively drive rotation of the first pivot element, the second pivot element being operatively connected to be passively driven in response to rotation of the first pivot element.

15. A method for wiping a window according to claim 12, wherein the motor driver is operatively connected to the first and second pivot elements so as to actively drive rotation of the first and second pivot elements.
